(19) United States
(12) Patent Application Publication
(10) Pub. No.: US 2005/0126308 A1
(43) Pub. Date: Jun. 16, 2005

(54) Rotation detecting device and method of manufacturing same

(75) Inventors: Hiroyuki Tsuge, Nissin-city (JP); Masayuki Furuhashi, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 10/974,680

(22) Filed: Oct. 28, 2004

(30) Foreign Application Priority Data
Dec. 10, 2003 (JP) 2003-411866

(51) Int. Cl. G01L 1/00

(52) U.S. Cl. 73/862.322

(57) ABSTRACT

A rotation detecting device includes a housing that has an open end, a bottom end and an inside wall, and a rotation sensing unit disposed inside the housing. The rotation sensing unit includes an IC unit and a shape adjusting member that covers the IC unit. The shape adjusting member has an outer periphery fitted to the inside wall of the housing to hold the IC unit tight in the housing.

### CROSS REFERENCE TO RELATED APPLICATION

The present application is based on and claims priority from Japanese Patent Application 2003-411866, filed Dec. 10, 2003, the contents of which are incorporated herein by reference.

### BACKGROUND OF THE INVENTION

1. Field of the Invention

The present invention relates to a rotation detecting device that detects rotation of a rotor and a method of manufacturing such a rotation detecting device. The rotation detecting device is preferably used for a vehicle.

2. Description of the Related Art

JP-A-2000-171475 discloses an ordinary rotation detecting device. The disclosed rotation detecting device includes a sensor section that provides a rotation signal related to rotation of a rotor, a resinous sensor housing and a signal cable for transmitting the rotation signal. The sensor section and the signal cable are connected via a metal terminal. The sensor section is mechanically connected to or clamped by one end of the metal terminal, while the signal cable is soldered to the other end of the metal terminal.

The sensor section is formed in an IC unit, and the housing has a shape to accommodate the IC unit. Therefore, a different housing is necessary if the IC unit has different shape. There is an IC unit that can not endure pressure and/or temperature applied to it while it is molded with the housing. In this case, it is necessary to cover such an IC unit with a thermosetting resinous material before molding by such as potting or injection molding. However, an additional work time is necessary for the potting, or an expensive die is necessary for the injection molding.

### SUMMARY OF THE INVENTION

Therefore, an object of the invention is to provide an inexpensive rotation detecting device that is adaptable to various shaped of the IC unit in which the sensor section is formed.

According to a feature of the invention, a rotation detecting device includes a housing that has an open end, a bottom end and an inside wall and a rotation sensing unit disposed inside the housing. With the above structure, the rotation sensing unit includes an IC unit and a shape adjusting member that covers the IC unit. The shape adjusting member has an outer periphery fitted to the inside wall of the housing to hold the IC unit tight in the housing. Therefore, it is not necessary to provide various types of housing even if the IC unit has a different size or shape. Because the IC unit is covered with the shape adjusting member, the IC unit is protected from heat while it is manufactured or vibration while it is in use.

In the above rotation detecting device, the rotation sensing unit further includes terminals extending from the IC unit. Therefore, the terminals are protected from vibration or high temperature.

The above rotation detecting device may include a resinous member filled between the outer periphery of the shape adjusting member and the inside wall of the housing in order to protect the rotation sensing unit from vibration more securely.

In the above rotation detecting device the housing may be a hollow rectangular pole that has a rectangular cross section. In this case, the housing has a pair of side members and a stepped portion at one of the pair of side members, and the shape adjusting member has a stepped portion on the portion corresponding to the stepped portion of the side member. The housing may have a longitudinal groove on one of the pair of side members inside said housing so that the resinous member can fill the groove to tightly bond the rotation sensing unit to the housing. In addition, the housing may have a flange that expands outward from the pair of side members, so that the resinous material can be easily introduced into the housing.

Another object of the invention is to provide a method of manufacturing an inexpensive rotation detecting device that is adaptable to various shaped of the IC unit in which the sensor section is formed.

According to another feature of the invention, a method of manufacturing a rotation detecting device is comprised of a step of connecting the signal cable to the rotation sensing unit, a step of forming a shape adjusting member on an IC unit so that the shape adjusting member can cover at least a portion of the IC unit and the lead wire to form the rotation sensing unit the outer periphery of which fits the inner wall of the housing, a step of inserting the rotation sensing unit into the housing, and a step of filling resinous material into the inside of the housing.

Therefore, it is not necessary to provide various types of housing even if the IC unit has a different size or shape.

In the above method, the step of forming a shape adjusting member is preferably formed by a method of hot-melt molding. Although, the shape adjusting member can be formed by other method such as potting or injection molding, the shape adjusting member can be formed by the method of hot-melt molding more quickly under lower temperature and lower pressure.

According to another feature of the invention, a method of manufacturing a rotation detecting device that has a housing and a rotation sensing unit is comprised of a step of selecting an IC unit having an outer periphery from IC units having various outer peripheries, a step of connecting a lead wire to the selected IC unit, a step of forming a shape adjusting member on the IC unit if the outer periphery thereof does not fit the inner wall of the housing so that the shape adjusting member can cover at least a portion of the IC unit and the lead wire to form the rotation sensing unit the outer periphery of which fits the inner wall of the housing, a step of inserting the rotation sensing unit into the housing and a step of filling resinous material into the inside of the housing.

According to another feature of the invention, a method of manufacturing a rotation detecting device that has a housing and a rotation sensing unit that includes an IC unit includes a step of providing a plurality of types of IC units having various outer peripheries, a step of selecting one type of IC unit, a step of connecting a lead wire to the selected IC unit, a step of providing a housing that has an inside in which any of the plurality of types of IC units can be inserted, a step of forming a shape adjusting member on the selected IC unit if the outer periphery thereof does not fit the inner wall of the housing so that the shape adjusting member can cover at least a portion of the IC unit and the lead wire to form the rotation sensing unit the outer periphery of which fits the inner wall of the housing, a step of inserting the rotation sensing unit into the housing and a step of filling resinous material into the inside of the housing.

### BRIEF DESCRIPTION OF THE DRAWINGS

Other objects, features and characteristics of the present invention as well as the functions of related parts of the present invention will become clear from a study of the following detailed description, the appended claims and the drawings. In the drawings:

FIG. 1 is a schematic diagram illustrating a structure of mounting a wheel speed sensor according to the first embodiment of the invention;

FIG. 2 is an overall structure of the wheel speed sensor according to the first embodiment;

FIG. 3 is a longitudinal cross-sectional view of the wheel speed sensor according to the first embodiment;

FIGS. 4A and 4B illustrate how to mount a rotation detecting IC element into a housing;

FIG. 5 is an overall structure of the wheel speed sensor according to the second embodiment of the invention;

FIGS. 6A, 6B and 6C illustrate how to mount a rotation detecting IC element of the wheel speed sensor according to the second embodiment into a housing; and

FIGS. 7A and 7B are longitudinal side views respectively viewed from angles that are 90 degrees different from each other.

### DETAILED DESCRIPTION OF THE PREFERRED EMBODIMENTS

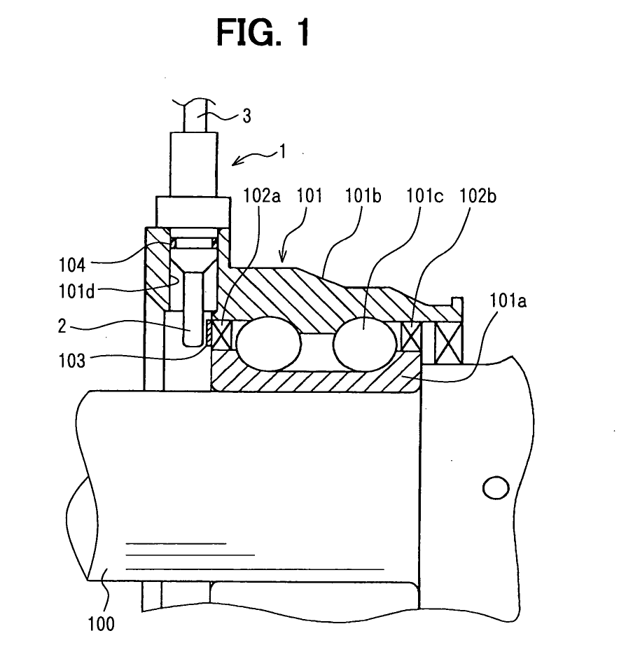

A rotation detecting device according to the first embodiment of the invention will be described with reference to FIGS. 1, 2, 3, 4A, 4B, 7A and 7B.

As shown in FIG. 1, an axle 100 has a bearing 101 at a portion near a wheel. The bearing 101 is composed of an inner ring 101a, an outer ring 101b and balls 10c. The inner ring 101a is fixedly fitted to the outer periphery of the wheel axle 100 to rotate with the same, and the outer ring 101b is fixed to a portion of a vehicle body, which is not shown. A pair of oil seal members 102a and 102b are respectively disposed between the inner ring 101a and the outer ring 101b at the opposite sides thereof to keep lubricating oil that is fed between the inner ring 101a and the outer ring 101b. The oil seal members 102a, 102b are fixed to the inner ring 101a to rotate together, and a magnetized rotor 103 is fixed to the oil seal member 102a to rotate together when the inner ring 102a rotates. The magnetized rotor 103 is a ring-shaped rotor which surrounds the wheel axle 100 and is magnetized to have pairs of N pole and S pole in the circumferential direction thereof.

The outer ring 101b has a bore 101d in which a wheel speed sensor 1 is force-fitted. The wheel speed sensor 1 has a rotation sensing unit 2 that projects from the bore 10d to confront the magnetized rotor 103 and a signal cable 3. An O-ring 104 is disposed between an outer periphery of the wheel speed sensor 1 and the inner surface of the bore 101d to prevent water from entering into the inside.

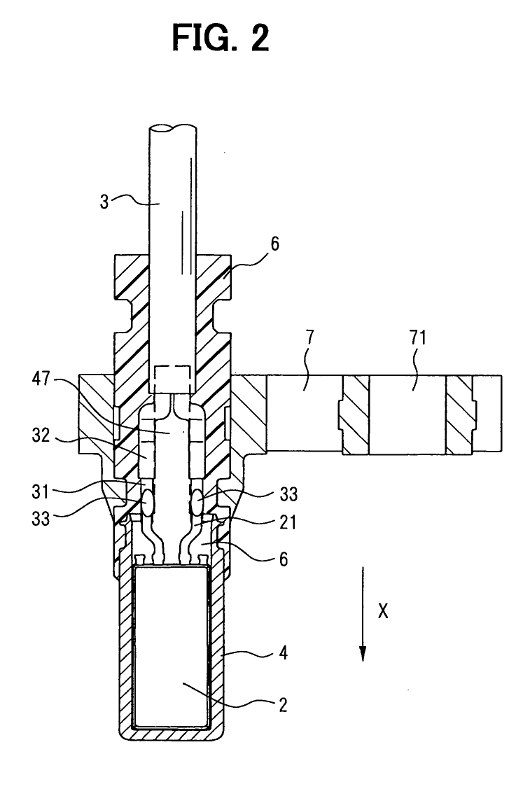

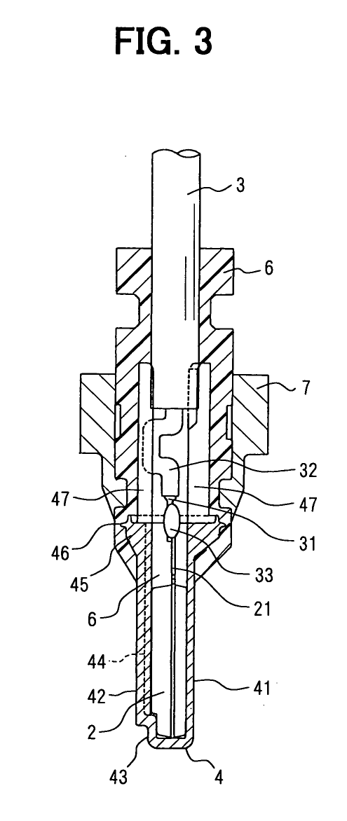

As shown in Fig. FIGS. 2 and 3, the rotation sensing unit 2 is accommodated in a housing 4. The rotation sensing unit 2 includes a MRE (Magneto Resistive Effect) element, an IC chip on which a signal processing circuit is formed, a permanent magnet and a pair of terminals 21. Those elements are molded with resinous material into a unit. The rotation sensing unit 2 has a stepped portion at the left end corner thereof in FIG. 3 to prevent miss-insertion of the unit 2 into the housing 4.

The housing 4 is a hollow rectangular pole that has an open end, a bottom end and a rectangular cross-section in the direction perpendicular to a direction X indicated in FIG. 2. As shown in FIG. 3, the housing 4 has a front side member 41 on the side thereof confronting the magnetized rotor 103 and a stepped portion 43 at the bottom end on a back side member 42 behind the side member 41. The stepped portion 43 is formed at a portion corresponding to the stepped portion of the rotation sensing unit 2 to prevent miss-insertion thereof. The back side member 42 has a longitudinal groove 44 in parallel to the direction X at the inner surface thereof. The groove 44 provides a gap between the housing 4 and the rotation sensing unit 2. In other words, the rotation sensing unit 2 is closely fitted into the housing 4 except the groove 44. The open end of the housing 4 has a flange 45 that expands outward from the front side member 41 and the back side member 42, a projection 46 projecting from a portion of the flange 45 on the back side member 42 in a direction perpendicular to the direction X and a pair of support poles 47 that projects from the flange 45 in parallel to the direction opposite the direction X.

As shown in FIGS. 2 and 3, the rotation sensing unit 2 has a pair of terminals 21. The signal cable 3 has a pair of lead wires 31, each of which is composed of a plurality of twisted strands and a wire cover 32, and a cable cover. Each lead wire 31 is welded at its one end to one of the terminal 21 by a well-known welder, such as a micro TIG welder. The other end of the pair of lead wires 31 is connected to an outside device such as an ECU (Electronic Control Unit) of an ABS (Antilock Blake System) or the like. The pair of wires 31 are supported by the support poles 47 to be tightly held in the housing 4.

The wheel speed sensor 1 according to the first embodiment is manufactured as follows.

Firstly, the cable cover is removed so as to extract the wire covers 32 of the lead wires 31. Then, the wire covers 32 are removed to extract the strands of the lead wires 31. Thereafter, one end of each lead wire 31 is connected to one of the terminals 21 by a welder, a solder or other mechanical means.

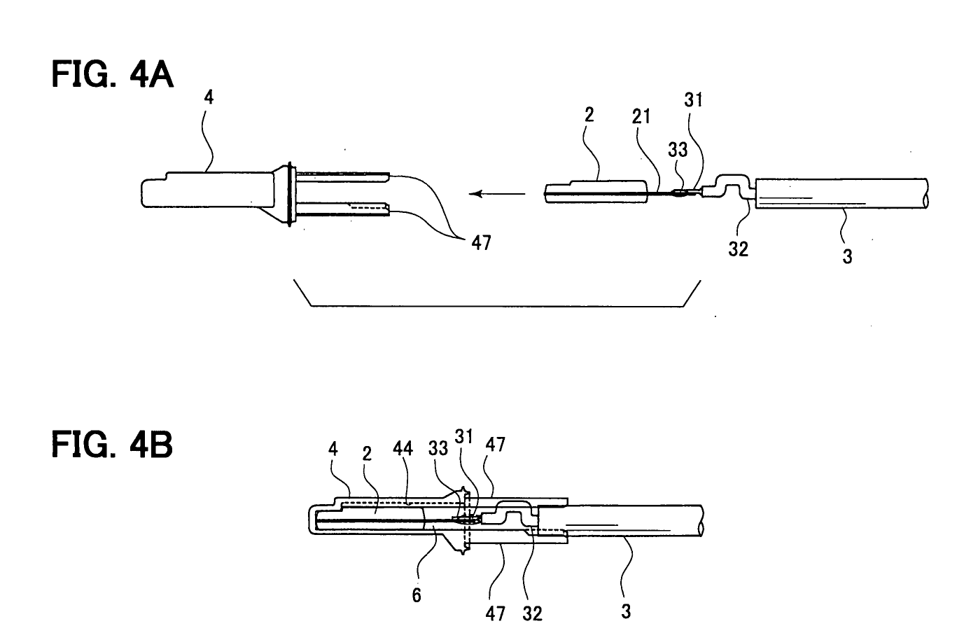

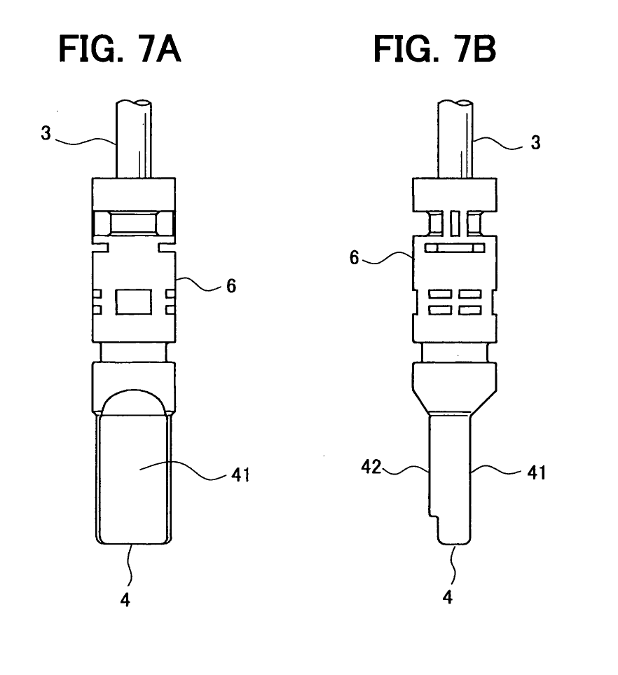

Subsequently, the rotation sensing unit 2 is inserted into the housing, while the signal cable 3 is supported by the support poles 47, as sown in FIGS. 4A and 4B. Finally, resinous material 6 is filled from the open end of the housing 4 into the inside of the housing 4 to hold the rotation sensing unit 2, the terminals 21 and the lead wires 31. Thus, the wheel speed sensor according to the first embodiment is provided, as shown in FIGS. 7A and 7B, and fixed to a prescribed portion of a vehicle via a stay 7 which has a fixing hole 71 for a fastening bolt. Because a portion of the resinous material 6 fills the groove 44 the rotation sensing unit 2 is tightly held in the housing 4. Therefore, a vibration durable wheel speed sensor 1 can be provided.

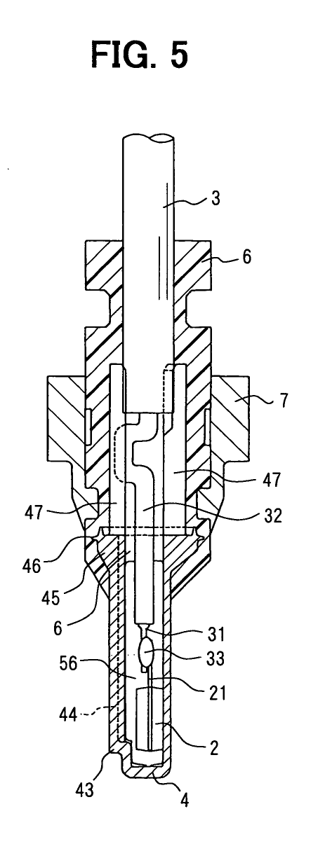

A wheel speed sensor according to the second embodiment of the invention will be described with reference to FIGS. 5, 6A, 6B, 6C, 7A and 7B.

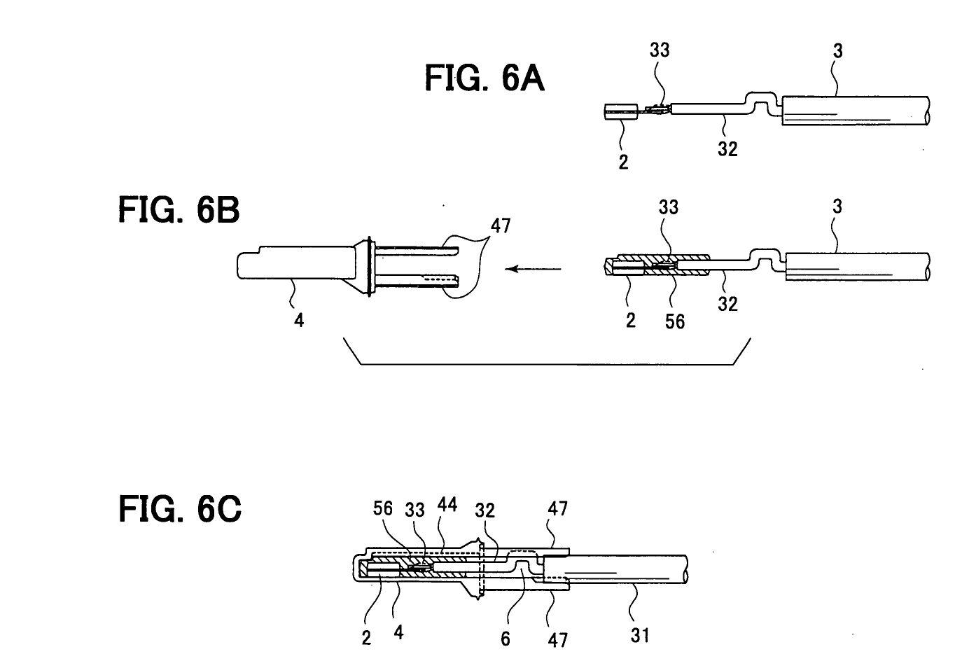

The wheel speed sensor 1 includes a rotation sensing unit 2 whose size is comparatively smaller than the inside size of the housing 4. As shown in FIG. 6A, after the terminals and the led wires 31 are connected together, shape-adjusting resinous material 56 is formed by a method of hot-melt molding to fit to the inside shape of the housing so as to hold the rotation sensing unit 2, the terminals 21 and the lead wires 31. Then, the molded unit 2 is inserted into the housing 4, as shown in FIG. 6B and FIG. 6C. The rotation sensing unit 2 according to the second embodiment of the invention also has a stepped portion at the left end corner thereof to prevent miss-insertion of the unit 2 into the housing 4, which has a corresponding stepped portion. Finally, resinous material 6 is filled from the open end of the housing 4 into the inside of the housing 4 to hold the molded rotation sensing unit 2. Because a portion of the resinous material 6 fills the groove 44 the rotation sensing unit 2 is tightly held in the housing 4. Thus, the wheel speed sensor according to the second embodiment whose outside size is identical to the wheel sensor according to the first embodiment can be provided without changing the shape of members to mount in a vehicle body, as shown in FIGS. 7A and 7B.

In the foregoing description of the present invention, the invention has been disclosed with reference to specific embodiments thereof. It will, however, be evident that various modifications and changes may be made to the specific embodiments of the present invention without departing from the scope of the invention as set forth in the appended claims. Accordingly, the description of the present invention is to be regarded in an illustrative, rather than a restrictive, sense.

1. A rotation detecting device comprising:
a housing that has an open end, a bottom end and an inside wall; and
a rotation sensing unit disposed inside said housing;
wherein said rotation sensing unit comprises an IC unit and a shape adjusting member that covers said IC unit, and
said shape adjusting member has an outer periphery fitted to the inside wall of said housing to hold said IC unit tight in said housing.

2. The rotation detecting device as claimed in claim 1,
wherein said rotation sensing unit further comprises terminals extending from said IC unit.

3. The rotation detecting device as claimed in claim 1, further comprising a resinous member filled between the outer periphery of said shape adjusting member and the inside wall of said housing.

4. The rotation detecting device as claimed in claim 1,
wherein said housing is a hollow rectangular pole that has a rectangular cross section.

5. The rotation detecting device as claimed in claim 4,
wherein said housing has a pair of side members and a stepped portion at one of the pair of side members, and
wherein said shape adjusting member has a stepped portion on the portion thereof corresponding to the stepped portion of the side member.

6. The rotation detecting device as claimed in claim 5,
wherein said housing has a longitudinal groove on one of said pair of side members inside said housing.

7. The rotation detecting device as claimed in claim 5,
wherein said housing has a flange that expands outward from the pair of side members.

8. A method of manufacturing a rotation detecting device that has a housing and a rotation sensing unit disposed inside the housing and a lead wire for connecting the rotation sensing unit to an outside device, said method comprising:
a step of connecting the signal cable to the rotation sensing unit;
a step of forming a shape adjusting member on an IC unit so that the shape adjusting member can cover at least a portion of the IC unit and the lead wire to form the rotation sensing unit the outer periphery of which fits the inner wall of the housing;
a step of inserting the rotation sensing unit into the housing; and
a step of filling resinous material into the inside of the housing.

9. The method as claimed in claim 8, said step of forming a shape adjusting member is made by a method of hot-melt molding.

10. A method of manufacturing a rotation detecting device that has a housing and a rotation sensing unit that has an IC unit and is disposed inside the housing and a lead wire for connecting the rotation sensing unit to an outside device, said method comprising:
a step of selecting an IC unit having an outer periphery from IC units having various outer peripheries;
a step of connecting the lead wire to the selected IC unit;
a step of forming a shape adjusting member on the IC unit if the outer periphery thereof does not fit the inner wall of the housing so that the shape adjusting member can cover at least a portion of the IC unit and the lead wire to form the rotation sensing unit the outer periphery of which fits the inner wall of the housing;
a step of inserting the rotation sensing unit into the housing; and
a step of filling resinous material into the inside of the housing.

11. A method of manufacturing a rotation detecting device that has a housing and a rotation sensing unit that includes an IC unit and disposed inside the housing and a lead wire for connecting the rotation sensing unit to an outside device, said method comprising:
a step of providing a plurality of types of IC units having various outer peripheries;
a step of selecting one type of IC unit;
a step of connecting the lead wire to the selected IC unit;
a step of providing a housing that has an inside in which any of the plurality of types of IC units can be inserted;
a step of forming a shape adjusting member on the selected IC unit if the outer periphery thereof does not fit the inner wall of the housing so that the shape adjusting member can cover at least a portion of the IC unit and the lead wire to form the rotation sensing unit the outer periphery of which fits the inner wall of the housing;
a step of inserting the rotation sensing unit into the housing; and
a step of filling resinous material into the inside of the housing.
